(19) United States
(12) Patent Application Publication
(10) Pub. No.: US 2015/0033364 A1
(43) Pub. Date: Jan. 29, 2015

(54) Method and Apparatus for the Protection of Application Software

(71) Applicant: GOLDEN VAST MACAO COMMERCIAL OFFSHORE LIMITED, Macao (CN)

(72) Inventor: Kwok Fong Wong, Macao (CN)

(73) Assignee: GOLDEN VAST MACAO COMMERCIAL OFFSHORE LIMITED, Macao (CN)

(21) Appl. No.: 14/187,064

(22) Filed: Feb. 21, 2014

(30) Foreign Application Priority Data
Jul. 27, 2013 (CN) 201310321354.1

(51) Int. Cl. G06F 21/32

(52) U.S. Cl. CPC G06F 21/32
USPC 726/28

(57) ABSTRACT

A method for the protection of an application comprises: receiving a command for locking the specified application; extracting user's biometric information; using the user's biometric information to lock the specified application. Furthermore, an apparatus for the protection of an application comprises: a receiving module, a extraction module and a locking module. In the invention, the user's biometric information is obtained and used to lock the specified application, so that the specified application can be locked and the user can use other applications conveniently; furthermore, the protection of the specified application is also improved.

This application claims priority to CN Patent Application Ser. No.201310321354.1 filed 27 Jul. 2013.

### TECHNICAL FIELD

The invention relates to the field of communication technology, particularly to a method and apparatus for application protection.

### BACKGROUND ART

With the development of communication technology, the functions of mobile phones and other mobile terminals become increasingly powerful. People can not only make calls and send messages through mobile terminal, but also install instant communication software, drawing software, game software and other software applications on mobile terminal, so that they can conduct instant communication, draw pictures, play games and do other things using such software applications through mobile terminal.

To avoid unauthorized use of the software applications on the mobile terminal, the software applications are generally protected by locking the mobile terminal screen (i.e. screen saver).

However, not all of the software applications on the mobile terminal need to be protected, and screensaver password can be easily cracked with poor security.

### SUMMARY OF THE INVENTION

To solve the problems of the prior art, the embodiments of the invention provide a method and apparatus for application protection. The technical solution is as follows:

In one aspect, it provides a method for application protection, and the said method comprises:

Receiving a command for locking the specified application;

Extracting the user's biometric information;

Using the user's biometric information to lock the specified application, so as to achieve locking of the specified application;

In the other aspect, it provides an apparatus for application protection, and the said apparatus comprises:

The first receiving module for receiving a command to lock the specified application;

The first extraction module for extracting the user's biometric information;

The locking module for using the user's biometric information to lock the specified application, so as to achieve application locking;

The technical solution provided by the embodiments of the invention has the following beneficial effect:

Through obtaining and using the user's biometric information to lock the specified application, the specified application can be locked, so that the user can use other applications conveniently and the security of the specified application can be improved.

### DESCRIPTION OF THE FIGURES

To more clearly illustrate the technical solution of the embodiments of the invention, the accompanying figures to be used for the description of the embodiments will be briefly introduced. Apparently, the accompanying figures described below are only some embodiments of the invention. For those skilled in the art, other figures can be obtained based on these figures without creative effort.

FIG. 1 is the flowchart of one method for application protection according to Embodiment 1 of the invention;

FIG. 2 is the flowchart of one method for application protection according to Embodiment 2 of the invention;

FIG. 3 is the flowchart of one method for application protection according to Embodiment 3 of the invention;

FIG. 4 is the schematic block diagram of the first apparatus for application protection according to Embodiment 4 of the invention;

FIG. 5 is the schematic block diagram of the second apparatus for application protection according to Embodiment 4 of the invention;

FIG. 6 is the schematic block diagram of the third apparatus for application protection according to Embodiment 4 of the invention;

FIG. 7 is the schematic block diagram of the fourth apparatus for application protection according to Embodiment 4 of the invention;

### DETAILED DESCRIPTION OF THE PREFERRED EMBODIMENTS

To make the purpose, technical solution and advantages of the invention more apparent, the embodiments of the invention will be further described below in detail with reference to the accompanying figures.

### Embodiment 1

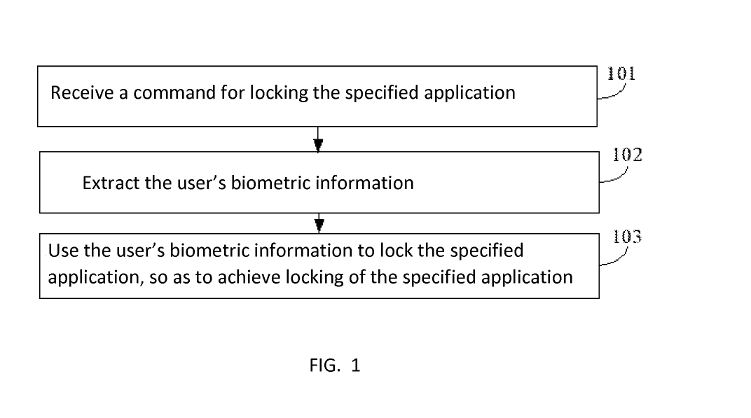

The embodiment of the invention provides a method for application protection, as illustrated in FIG. 1, and the said method comprises:

101: Receiving a command for locking the specified application;

102: Extracting the user's biometric information;

103: Using the user's biometric information to lock the specified application, so as to achieve locking of the specified application;

Preferably, the method further comprises:

Obtaining the command to start the locked application;

Extracting the user's biometric information;

Conducting user identity authentication based on the extracted user's biometric information;

Unlocking and starting the locked application if the user identity authentication is successful.

Preferably, the method still comprises:

Determining whether the time during which the unlocked application has not been operated exceeds the preset time interval;

Relocking the unlocked application if the preset time is exceeded;

Preferably, the user identity authentication based on the extracted user's biometric information comprises:

Comparing the extracted user's biometric information with the pre-stored user's biometric information;

The user identity authentication is successful if the extracted user's biometric information is consistent with the pre-stored user's biometric information.

Preferably, the method also comprises:

Pre-extracting the user's biometric information;

Storing the pre-extracted user's biometric information in the preset memory;

Preferably, prior to receiving the command to lock the specified application, the method further comprises:

Obtaining the serial number of the biometric information apparatus connected with the mobile terminal;

Authenticating the connected biometric information apparatus according to the serial number of the biometric information apparatus connected with the mobile terminal;

Receiving the user's biometric information extracted through the said biometric information apparatus if the authentication of the connected biometric information apparatus is successful;

Conducting user identity authentication based on the extracted user's biometric information;

Determining that the user can specify the application to be locked on the mobile terminal if the user identity authentication is successful;

Preferably, the method still comprises: Obtaining the command to start the locked application;

Obtaining the serial number of the biometric information apparatus connected with the mobile terminal;

Authenticating the connected biometric information apparatus according to the serial number of the biometric information apparatus connected with the mobile terminal;

Extracting the user's biometric information if the authentication of the connected biometric information apparatus is successful;

Conducting user identity authentication based on the extracted user's biometric information;

Unlocking and starting the locked application if the user identity authentication is successful.

Preferably, the authentication of the connected biometric information apparatus according to the serial number of the biometric information apparatus connected with the mobile terminal comprises:

Comparing the serial number of the biometric information apparatus connected with the mobile terminal with the pre-stored serial number of the biometric information apparatus corresponding to the mobile terminal;

The authentication of the connected biometric information apparatus is successful if the serial number of the biometric information apparatus connected with the mobile terminal is consistent with the pre-stored serial number of the biometric information apparatus corresponding to the mobile terminal.

Preferably, the user's biometric information includes at least one of the following items:

Fingerprint information, iris information, capillary vessel information, facial expression information and facial feature information.

The method for application protection according to the embodiment of the invention, wherein the user's biometric information is obtained and used to lock the specified application, so that the specified application can be locked and the user can use other applications conveniently; furthermore, the security of the specified application is also improved. The user identity authentication is conducted according to the extracted user's biometric information, and the application can be used only if the user identity authentication is successful, so that the security of the specified application is further improved.

### Embodiment 2

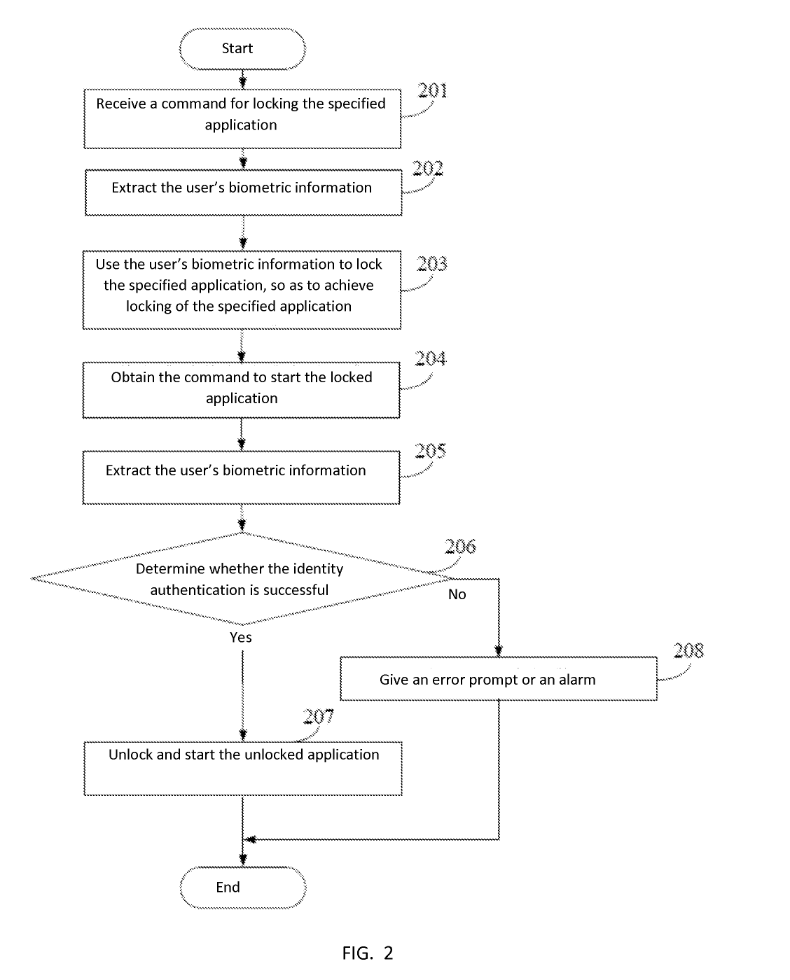

The embodiment of the invention provides a method for application protection, as illustrated in FIG. 2, and the said method comprises:

201: Receiving a command for locking the specified application;

Specifically, the user accesses the application locking setting screen, and chooses to lock some applications according to the specific circumstances.

202: Extracting the user's biometric information.

Wherein, the user's biometric information includes at least one of the following items:

Fingerprint information, iris information, capillary vessel information, facial expression information and facial feature information.

203: Using the user's biometric information to lock the specified application, so as to achieve locking of the specified application;

Specifically, the icon of the locked application displays a locking mark, so as to indicate that the application is locked.

204: Obtaining the command to start the locked application;

Specifically, the mobile terminal user can click the icon of the locked application or the PC user can double-click the icon of the locked application or right-click the icon of the locked application to select startup from the menu, so as to send the command to start the locked application.

205: Extracting the user's biometric information;

206: Conducting user identity authentication based on the extracted user's biometric information; 207 will be executed if the user identity authentication is successful; otherwise, 208 will be executed.

Specifically, the user identity authentication based on the extracted user's biometric information comprises:

Comparing the extracted user's biometric information with the pre-stored user's biometric information;

The user identity authentication is successful if the extracted user's biometric information is consistent with the pre-stored user's biometric information;

The user identity authentication fails if the extracted user's biometric information is inconsistent with the pre-stored user's biometric information.

Specifically, the user's biometric information can be pre-extracted; the pre-extracted user's biometric information is stored in the preset memory. When the user identity authentication is conducted, the pre-stored user's biometric information is obtained from the preset memory.

207: Unlocking and starting the unlocked application, and ending.

Specifically, after the locked application is unlocked and started, the user can use the application normally.

And, specifically, upon the startup of the unlocked application, the method further comprises:

Determining whether the time during which the unlocked application has not been operated exceeds the preset time interval;

Relocking the unlocked application if the preset time is exceeded;

208: Giving an error prompt or an alarm, and ending.

Specifically, in addition to error prompt and alarm, a hint that the user can not use the application can also be given in other ways, such as flashing.

Moreover, it should be noted that when making payment using NFC, you need to preinstall a NFC payment application on the mobile phone or any other mobile terminal. In case that the mobile terminal with NFC payment application is lost, any person who gets the mobile terminal can use the payment function, resulting in loss to the user. Thus, the NFC payment application can be locked using the method according to the embodiment of the invention. Under the circumstance that the NFC payment application is locked, even if the mobile terminal with the NFC payment application is lost, the others still can not use the NFC payment application to make payment, thereby further ensuring the security of the NFC payment.

The method for application protection according to the embodiment of the invention, wherein the user's biometric information is obtained and used to lock the specified application, so that the specified application can be locked and the user can use other applications conveniently; furthermore, the security of the specified application is also improved. The user identity authentication is conducted according to the extracted user's biometric information, and the application can be used only if the user identity authentication is successful, so that the security of the specified application is further improved.

### Embodiment 3

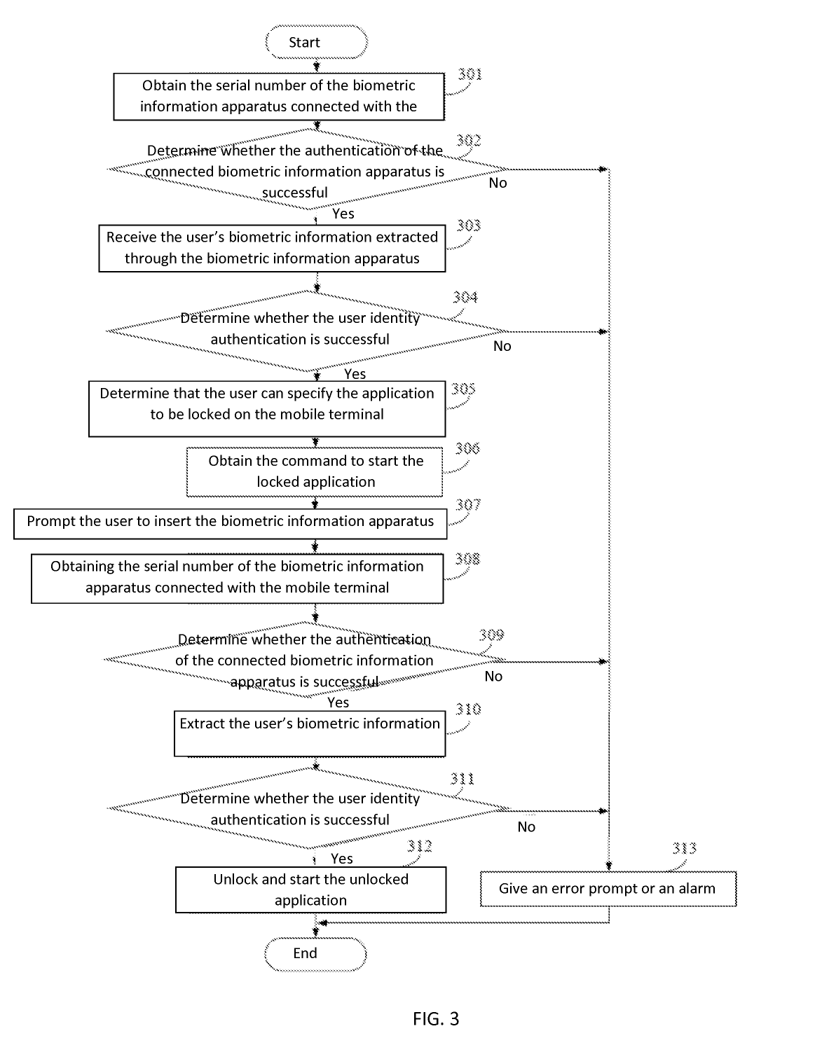

The embodiment of the invention provides a method for application protection, as illustrated in FIG. 3, and the said method comprises:

301: Obtaining the serial number of the biometric information apparatus connected with the mobile terminal.

302: Authenticating the connected biometric information apparatus according to the serial number of the biometric information apparatus connected with the mobile terminal, and determining whether the authentication of the connected biometric information apparatus is successful; 303 will be executed if the authentication is successful; otherwise, 313 will be executed.

Specifically, the serial number of the biometric information apparatus can be pre-registered and pre-stored in the mobile terminal, and one mobile terminal can register the serial number of more than one biometric information apparatus.

Specifically, the authentication of the connected biometric information apparatus according to the serial number of the biometric information apparatus connected with the mobile terminal comprises:

Comparing the serial number of the biometric information apparatus connected with the mobile terminal with the pre-stored serial number of the biometric information apparatus corresponding to the mobile terminal;

The authentication of the connected biometric information apparatus is successful if the serial number of the biometric information apparatus connected with the mobile terminal is consistent with the pre-stored serial number of the biometric information apparatus corresponding to the mobile terminal;

The authentication of the connected biometric information apparatus fails if the serial number of the biometric information apparatus connected with the mobile terminal is inconsistent with the pre-stored serial number of the biometric information apparatus corresponding to the mobile terminal.

303: Receiving the user's biometric information extracted through the biometric information apparatus.

Wherein, the user's biometric information includes at least one of the following items: fingerprint information, iris information, capillary vessel information, facial expression information and facial feature information. Accordingly, the biometric information apparatus includes at least one of the following apparatuses: fingerprint sensor, iris recognizer, capillary vessel recognizer and facial recognizer.

304: Conducting user identity authentication based on the extracted user's biometric information, and determining whether the user identity authentication is successful; 305 will be executed if the user identity authentication is successful; otherwise, 313 will be executed.

305: Determining that the user can specify the application to be locked on the mobile terminal, receiving the command to lock the specified application, and locking the specified application using the user's biometric information, so as to achieve locking of the specified application;

Specifically, if the user identity authentication is successful, it is determined that the user is the authorized user of the mobile terminal and can use the mobile terminal, so that the user can access the FingerQ application management center installed on the mobile terminal for application locking setting, start the FingerQ application, specify the application to be locked on the application locking setting screen of the FingerQ application, and lock the specified application.

Specifically, on the application locking setting screen, the icon of the locked application can be displayed as a locking icon (i.e. the icon of the unlocked application is different from that of the locked application). On the other screens, the icon of the locked application can be displayed as a normal icon (i.e. the icon is the same whether the application is locked or not), and the user knows whether the application is locked or not at the time of operating the application.

306: Obtaining the command to start the locked application.

307: Prompting the user to insert the biometric information apparatus.

308: Obtaining the serial number of the biometric information apparatus connected with the mobile terminal.

Specifically, to use a locked application, the user needs to connect the biometric information apparatus with the mobile terminal. Wherein, the biometric information apparatus is connected with the mobile terminal through the communication interface on the mobile terminal. The biometric information apparatus is provided with an interface corresponding to the type of the communication interface of the mobile terminal, so as to achieve connection. If the communication interface of the mobile terminal is a Micro USB interface, the interface of the biometric information apparatus should also be a Micro USB interface.

309: Authenticating the connected biometric information apparatus according to the serial number of the biometric information apparatus connected with the mobile terminal, and determining whether the authentication of the connected biometric information apparatus is successful; 310 will be executed if the authentication is successful; otherwise, 313 will be executed.

Specifically, the authentication of the connected biometric information apparatus according to the serial number of the biometric information apparatus connected with the mobile terminal comprises:

Comparing the serial number of the biometric information apparatus connected with the mobile terminal with the pre-stored serial number of the biometric information apparatus corresponding to the mobile terminal;

The authentication of the connected biometric information apparatus is successful if the serial number of the biometric information apparatus connected with the mobile terminal is consistent with the pre-stored serial number of the biometric information apparatus corresponding to the mobile terminal;

The authentication of the connected biometric information apparatus fails if the serial number of the biometric information apparatus connected with the mobile terminal is inconsistent with the pre-stored serial number of the biometric information apparatus corresponding to the mobile terminal.

310: Extracting the user's biometric information.

311: Conducting user identity authentication based on the extracted user's biometric information; 312 will be executed if the user identity authentication is successful; otherwise, 313 will be executed.

312: Unlocking and starting the unlocked application, and ending.

It should be noted that with respect to the method according to the embodiment of the invention, the locked application can be unlocked and started only when both the authentication of the connected biometric information apparatus and the user identity authentication are successful, so as to achieve dual protection of the locked application for higher security. Moreover, even if the mobile terminal is connected with the PC or any other device and the data of the locked application is extracted, the extracted data is still encrypted.

313: Giving an error prompt or an alarm, and ending.

Moreover, it should be noted that when making payment using NFC, you need to preinstall a NFC payment application on the mobile phone or any other mobile terminal. In case that the mobile terminal with NFC payment application is lost, any person who gets the mobile terminal can use the payment function, resulting in loss to the user. Thus, the NFC payment application can be locked using the method according to the embodiment of the invention. Under the circumstance that the NFC payment application is locked, even if the mobile terminal with the NFC payment application is lost, the others still can not use the NFC payment application to make payment, thereby further ensuring the security of the NFC payment.

The method for application protection according to the embodiment of the invention, wherein the user's biometric information is obtained and used to lock the specified application, so that the specified application can be locked and the user can use other applications conveniently; furthermore, the security of the specified application is also improved. The user identity authentication is conducted according to the extracted user's biometric information, and the application can be used only if the user identity authentication is successful, so that the security of the specified application is further improved.

### Embodiment 4

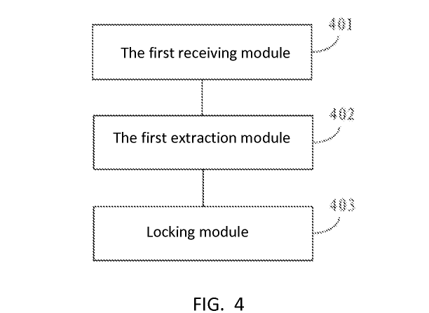

The embodiment of the invention provides an apparatus for application protection, as illustrated in FIG. 4, and the said apparatus comprises:

The first receiving module 401 for receiving a command to lock the specified application;

The first extraction module 402 for extracting the user's biometric information;

The locking module 403 for using the user's biometric information to lock the specified application, so as to achieve application locking;

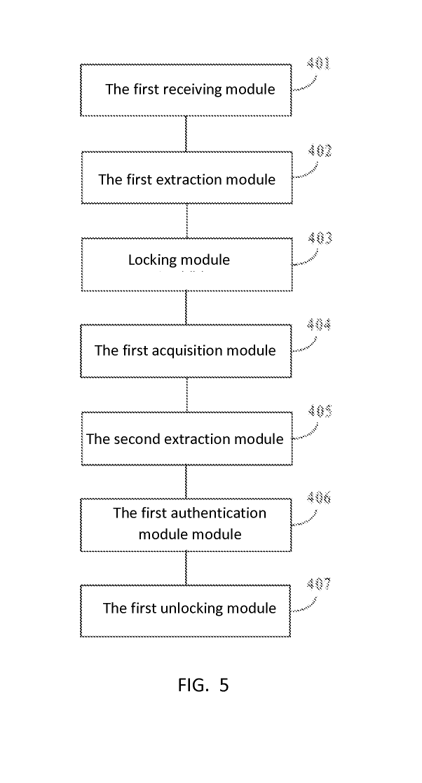

Preferably, as illustrated in FIG. 5, the apparatus further comprises:

The first acquisition module 404 for obtaining the command to start the locked application;

The second extraction module 405 for extracting the user's biometric information;

The first authentication module 406 for the user identity authentication based on the extracted user's biometric information;

The first unlocking module 407 for unlocking and starting the locked application if the user identity authentication is successful;

Preferably, the first authentication module 406 comprises:

The first comparing unit for comparing the extracted user's biometric information with the pre-stored user's biometric information;

The first authentication unit which successfully authenticates the user identity if the extracted user's biometric information is consistent with the pre-stored user's biometric information;

Specifically, the first extract module 402 and the second extraction module 405 can be a fingerprint sensor, facial recognizer, etc.

Preferably, the first authentication module 406 further comprises:

An extraction unit for pre-extracting the user's biometric information;

A memory unit for storing the pre-extracted user's biometric information in the preset memory;

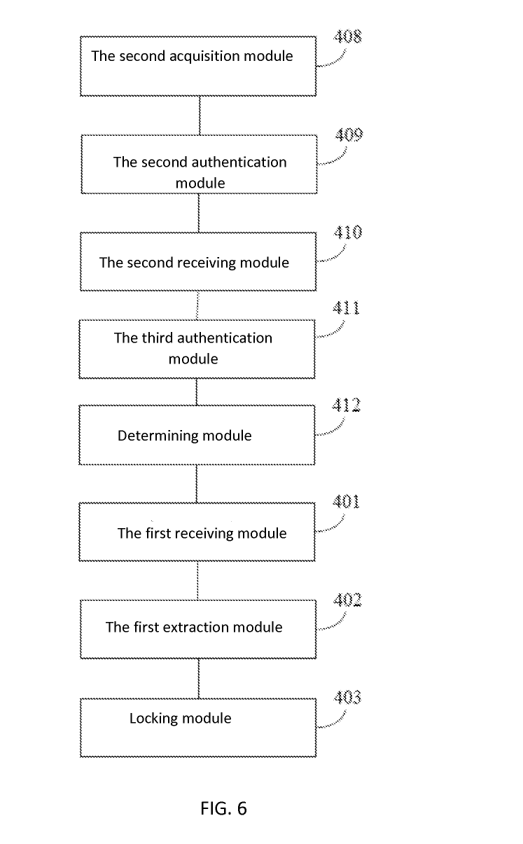

Preferably, as illustrated in FIG. 6, the apparatus further comprises:

The second acquisition module 408 for obtaining the serial number of the biometric information apparatus connected with the mobile terminal;

The second authentication module 409 for authenticating the connected biometric information apparatus according to the serial number of the biometric information apparatus connected with the mobile terminal;

The second receiving module 410 for receiving the user's biometric information extracted through the said biometric information apparatus if the authentication of the connected biometric information apparatus is successful;

The third authentication module 411 for conducting user identity authentication based on the extracted user's biometric information;

A determining module 412 for determining that the user can specify the application to be locked on the mobile terminal if the user identity authentication is successful;

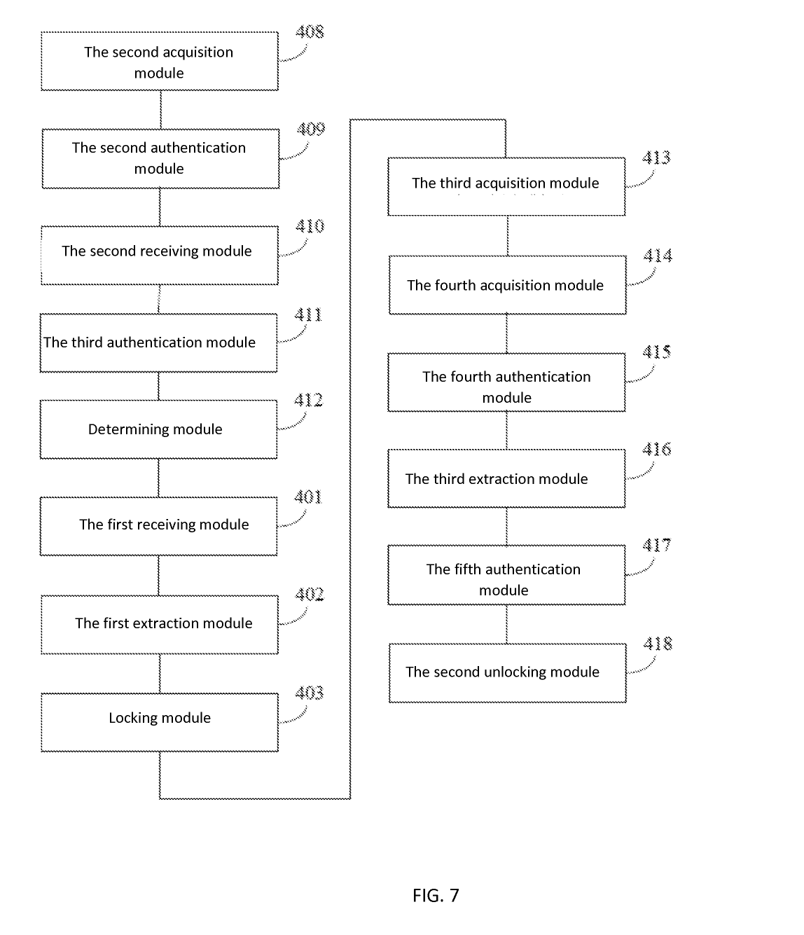

Preferably, as illustrated in FIG. 7, the apparatus still comprises:

The third acquisition module 413 for obtaining the command to start the locked application;

The fourth acquisition module 414 for obtaining the serial number of the biometric information apparatus connected with the mobile terminal;

The fourth authentication module 415 for authenticating the connected biometric information apparatus according to the serial number of the biometric information apparatus connected with the mobile terminal;

The third extraction module 416 for extracting the user's biometric information if the authentication of the connected biometric information apparatus is successful;

The fifth authentication module 417 for conducting user identity authentication based on the extracted user's biometric information;

The second unlocking module 418 for unlocking and starting the locked application if the user identity authentication is successful;

Preferably, the fourth authentication module 415 comprises:

The second comparing unit for comparing the serial number of the biometric information apparatus connected with the mobile terminal with the pre-stored serial number of the biometric information apparatus corresponding to the mobile terminal;

The second authentication unit which successfully authenticates the connected biometric information apparatus if the serial number of the biometric information apparatus connected with the mobile terminal is consistent with the pre-stored serial number of the biometric information apparatus corresponding to the mobile terminal.

Preferably, the user's biometric information includes at least one of the following items:

Fingerprint information, iris information, capillary vessel information, facial expression information and facial feature information.

The sequence numbers of the said embodiments of the invention are just used for the convenience of description, and do not represent the precedence of the embodiments.

The apparatus for application protection according to the embodiment of the invention, wherein the user's biometric information is obtained and used to lock the specified application, so that the specified application can be locked and the user can use other applications conveniently; furthermore, the security of the specified application is also improved. The user identity authentication is conducted according to the extracted user's biometric information, and the application can be used only if the user identity authentication is successful, so that the security of the specified application is further improved.

Those skilled in the art should understand that the whole or part of the steps to achieve the said embodiments can be completed through hardware or completed by instructing relevant hardware through programs, the said programs can be stored in a computer-readable storage medium, and the said storage medium can be a read-only memory, magnetic disk, optical disk, etc.

The above description only includes some of the preferred embodiments of the invention, and is not intended to limit the invention. Any modification, equivalent substitution and improvement made without departing from the spirit and principles of the invention shall be included within the scope of protection of the invention

What is claimed is:

1. A method for protecting an application comprises:
a) receiving a command for locking a specified application;
b) extracting a user's biometric information; and
c) locking the specified application by using the user's biometric information of step b);
wherein the application is an application software.

2. The method according to claim 1, wherein the method further comprises:
d) obtaining a command for starting a locked application;
e) extracting a user's biometric information;
f) authenticating a user identity authentication by using the extracted user's biometric information of step e); and
g) unlocking and starting the locked application.

3. The method according to claim 2, wherein the method further comprises:
comparing the extracted user's biometric information with the pre-stored user's biometric information;
authenticating the user identity authentication when the extracted user's biometric information is matched to the pre-stored user's biometric information.

4. The method according to claim 3, wherein the method further comprises:
pre-extracting the user's biometric information;
storing the pre-extracted user's biometric information in a computer memory.

5. The method according to claim 1, wherein prior to receiving the command for locking the specified application, the method further comprises:
obtaining a serial number of a biometric information apparatus connected with the mobile terminal;
authenticating the connected biometric information apparatus based on the serial number;
receiving the user's biometric information extracted through the biometric information apparatus if the authentication of the connected biometric information apparatus is verified;
conducting a user identity authentication based on the extracted user's biometric information;
determining the specified application for being locked by the user on the mobile terminal when the user identity authentication is authenticated.

6. The method according to claim 5, wherein the method further comprises:
obtaining the command to start the locked application;
obtaining the serial number of the biometric information apparatus connected with the mobile terminal;
authenticating the connected biometric information apparatus based on the serial number;
extracting the user's biometric information if the authentication of the connected biometric information apparatus is verified;
issuing the user identity authentication based on the extracted user's biometric information;
unlocking and starting the locked application if the user identity authentication is issued.

7. The method according to claim 6, wherein the authentication of the connected biometric information apparatus according to the serial number of the biometric information apparatus connected with the mobile terminal comprises:
comparing the serial number of the biometric information apparatus connected with the mobile terminal with the pre-stored serial number of the biometric information apparatus corresponding to the mobile terminal;
the authentication of the connected biometric information apparatus is verified if the serial number of the biometric information apparatus connected with the mobile terminal matched with the pre-stored serial number of the biometric information apparatus corresponding to the mobile terminal.

8. The method according to claim 1, wherein the user's biometric information is one or more selected for the group consisting of fingerprint information, iris information, capillary vessel information, facial expression information and facial feature information.

9. An apparatus for protecting an application, characterized in that the said apparatus comprises:
a first receiving module for receiving a command for locking a specified application;
a first extraction module for extracting a user's biometric information; and
a locking module for lock the specified application by using the user's biometric information;
wherein the application is an application software.

10. The apparatus according to claim 9, wherein the apparatus further comprises:
a first acquisition module for obtaining the command for starting a locked application;
a second extraction module for extracting a user's biometric information;
a first authentication module for authenticating a user identity authentication based on the extracted user's biometric information; and
a first unlocking module for unlocking and starting the locked application if the user identity authentication is authenticated.

11. The apparatus according to claim 10, wherein the first authentication module comprises:
a first comparing unit for comparing the extracted user's biometric information with a pre-stored user's biometric information; and
a first authentication unit for authenticating the user identity if the extracted user's biometric information matched with the pre-stored user's biometric information.

12. The apparatus according to claim 11, wherein the first authentication module further comprises:
an extraction unit for pre-extracting the user's biometric information; and
a memory unit for storing the pre-extracted user's biometric information in a computer memory.

13. The apparatus according to claim 9, wherein the apparatus further comprises:
a second acquisition module for obtaining a serial number of the biometric information apparatus connected with the mobile terminal;
a second authentication module for authenticating the connected biometric information apparatus according to the serial number;
a second receiving module for receiving the user's biometric information extracted through the said biometric information apparatus if the authentication of the connected biometric information apparatus is verified;
a third authentication module for authenticating the user identity authentication based on the extracted user's biometric information; and
a determining module for determining the specified application for being locked by the user on the mobile terminal if the user identity authentication is authenticated.

14. The apparatus according to claim 13, wherein the apparatus further comprises:
a third acquisition module for obtaining a command for starting a locked application;
a fourth acquisition module for obtaining the serial number of the biometric information apparatus connected with the mobile terminal;
a fourth authentication module for authenticating the connected biometric information apparatus based on the serial number of the biometric information apparatus connected with the mobile terminal;
a third extraction module for extracting the user's biometric information if the authentication of the connected biometric information apparatus is verified;
a fifth authentication module for authenticating the user identity authentication based on the extracted user's biometric information; and
a second unlocking module for unlocking and starting the locked application if the user identity authentication is authenticated.

15. The apparatus according to claim 14, wherein the fourth authentication module further comprises:
a second comparing unit for comparing the serial number of the biometric information apparatus connected with the mobile terminal with the pre-stored serial number of the biometric information apparatus corresponding to the mobile terminal; and
a second authentication unit for authenticating the connected biometric information apparatus if the serial number of the biometric information apparatus connected with the mobile terminal matched with the pre-stored serial number of the biometric information apparatus corresponding to the mobile terminal.

16. The apparatus according to claim 9, wherein the user's biometric information is one or more selected for the group consisting of fingerprint information, iris information, capillary vessel information, facial expression information and facial feature information.
